(19) United States
(12) Patent Application Publication
(10) Pub. No.: US 2014/0279396 A1
(43) Pub. Date: Sep. 18, 2014

(54) SYSTEM AND METHOD FOR PROCESSING VECTOR EXCEPTIONS

(71) Applicant: Capital One Financial Corporation, McLean, VA (US)

(72) Inventors: Anurag MAHAJAN, Sugar Land, TX (US); Christopher M. GRADNEY, New Orleans, LA (US)

(73) Assignee: Capital One Financial Corporation, McLean, VA (US)

(21) Appl. No.: 14/208,604

(22) Filed: Mar. 13, 2014

Related U.S. Application Data
(60) Provisional application No. 61/788,834, filed on Mar. 15, 2013.

(51) Int. Cl. G06Q 40/02

(52) U.S. Cl. CPC G06Q 40/025
USPC 705/38

(57) ABSTRACT

A system and method in accordance with example embodiments may determine whether or not an item requiring overdraft lending is eligible for the lending. Additionally, a system and method in accordance with example embodiments may receive a request to authorize an overdraft of an item and a first authorization credentials, determine whether or not the first authorization credentials are associated with a lending authority amount greater than the overdraft item request, and generate at least one message to at least one authorized user associated with a lending authority amount greater than the overdraft item request when the lending module determines the first authorized credentials are not associated with the lending authority amount great than the overdraft item request.

### CROSS-REFERENCE TO RELATED APPLICATIONS

This application claims priority to U.S. Provisional Patent Application No. 61/788,834, filed on Mar. 15, 2013, the entire contents of which is incorporated herein by reference.

This application contains subject matter related to U.S. patent application Ser. No. ______, filed on Mar. ______, 2014, entitled “System and Method for Determining Overdraft Protection”, the entire contents of which is incorporated herein by reference.

### FIELD OF DISCLOSURE

The present disclosure relates to systems and methods for processing vector exceptions used to approve overdrafts.

### BACKGROUND INFORMATION

Financial institutions may allow a customer to overdraft his or her account by honoring payments for an item that will bring the customer's available account balance below zero. The overdraft decision may be made by an associate with a particular lending authority amount, where the lending authority amount may depend on and vary by the line of business of the customer, such as, for example consumer, small business, and commercial. However, an associate may also approve an overdraft where the overdraft exceeds the associate's lending authority. Alternatively, an associated may escalate the item to a person with a higher lending authority for approval. These processes introduce a variety factors including regulatory, credit, and fraud risks. Additionally, these processes are labor intensive and inefficient. These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 is a schematic diagram illustrating a system for providing lending authority review for overdrafts;

FIG. 2 is a block diagram of a hardware components of a system for providing lending authority review for overdrafts;

FIG. 3 is a flowchart illustrating a method for determining whether to extend lending to cover an overdraft; and

FIG. 4 is a flowchart illustrating a method for performing an email decision process within the determination of whether to extend lending to cover an overdraft.

### DETAILED DESCRIPTION OF PREFERRED EMBODIMENTS

The following description is intended to convey a thorough understanding of the embodiments described by providing a number of specific example embodiments and details involving systems and methods for determining whether to extend lending to cover an overdraft of an account. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution as used as examples for the disclosure. The disclosure is not intended to be limited to financial institutions only.

According to various embodiments of the present disclosure, systems and methods enable determining whether to provide lending to cover an overdraft of an account. An overdraft may occur when a customer uses an account, but does not have the required funds available in the account to cover the payment item. When a customer incurs an overdraft, the customer may have to pay a fee to the bank once a customer replenishes the account with the appropriate funds. An overdraft may be used in various situations. For example, a customer that maintains an account with a financial institution may write a check with the mistaken assumption that the account linked to the check has enough funds to cover the value written on the check. As another example, a customer that maintains an account with a financial institution may make a payment using an account the customer knows does not have the funding to cover the item. However, the customer may know that funds will be credited to his or her account the following day that will cover the difference between the item and the available account funds as well as the fee incurred by using overdraft protection.

In an example embodiment, a customer may be a customer of a financial institution where the customer maintains an account. The financial institution may be connected via a network to and/or include within a vector exceptions system that handles the authorization of funding an overdraft. Customer system(s) may also be connected via a network to the financial institution where the customer maintains an account. The financial institution may maintain account data and customer data. Account data may include any, or a combination, of account type, account balance, account transaction details, and/or account debits and credits. Customer data may include any, or a combination, of customer name, customer address, customer date of birth, customer social security number, customer employment status, customer employer name, customer income, customer residential status (e.g., whether a customer rents or owns), customer monthly mortgage or rental payments, customer marital status.

In an example embodiment, the financial institution and vector exception system may also contain various modules to assist in processing overdraft decision. As used herein, the term “module” may be understood to refer to computer executable software, firmware, hardware, or various combinations thereof. It is noted that the modules are examples. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices. Modules may include hardware and software.

In an example embodiment, the financial institution system may include an input/output module that sends and receives data from a vector exceptions system and/or a customer system. The financial institution system may include a vector exceptions module that determines authorization to access a vector exceptions system. The authorization to access the system may be based, for example, on an employee identifier other login mechanism that may allow the vector exceptions system to determine whether a user as the authority to access the vector exceptions system. The financial institution may also include an account module that links an overdraft decisions to the account associated with the overdraft request.

In an example embodiment, a vector exceptions system may include a non-sufficient funding module that makes an initial determination of whether to attempt to authorize payment of an overdraft. A vector exceptions system may include a lending module to determine a lending authority associated with an authorized user. In various embodiments, an authorized user may refer to an employee or other decision maker associated with a financial institution and/or vector exceptions system that is authorized to make overdraft decisions on behalf of the financial institution. A vector exceptions system may also include an email module to determine email approval for overdraft payments when the lending module requests email approval and when email approval is enabled. A vector exceptions system may include an input/output module to facilitate communication between the vector exceptions system and a financial institution system

FIG. 1 depicts an example system 100 for use with an overdraft protection limit determination. System 100 may include a financial institution system 120, a vector exceptions system 130, and customer system(s) 140, all connected, for example, over a network 110. In example embodiments, network 110 may be one or more of a wireless network, a wired network or any combination of wireless network and wired network. For example, network 110 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 110 may include, without limitation, telephone lines, fiber optics, IEEE Ethernet 902.3, a wide area network (“WAN”), a local area network (“LAN”), or a global network such as the Internet. In addition, network 110 may support an Internet network, a wireless communication network, a cellular network, or the like, or any combination thereof. Network 110 may further include one network, or any number of the example types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

Financial institution system 120, vector exceptions system 130, and customer system(s) may each include a network-enabled computer system and/or device. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The network-enabled computer systems may further include data storage. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

FIG. 2 illustrates a block diagram of hardware components of a system for determining whether to extend lending to cover overdraft of an account according to a particular embodiment and specifically the components of a financial institution system 120 and a vector exceptions system 130.

Financial institution system 120 may include an input/output module 122 for sending data to and receiving data from a vector exceptions system 130 and/or a customer system 140. The financial system 120 may further include a vector exceptions module 124 for authorizing access to a vector exceptions system 130. Once a financial institution system 120 has access to a vector exceptions system 130, the input/output module 122 may facilitate communications between the financial institution system 120 and the vector exceptions system 130 in order to process an overdraft lending decision. The financial system 120 may also include an account module 126 for linking an overdraft decision to the account associated with the overdraft request. When an overdraft is approved, for example, using vector exceptions system 130, the account module 126 may add or otherwise indicate the approved overdraft authorization to the appropriate account and approve the overdraft funding. When an overdraft is denied, for example, using vector exceptions system 130, the account module 126 may mark or otherwise indicate the account associated with the payment item requiring overdraft approval accordingly so that an account owner may be notified.

Vector exceptions system 130 may include a non-sufficient funds (NSF) module 132 for providing an initial decision of whether or not to provide overdraft funding. If the NSF module 132 determines that payment is possible, the vector exceptions system 130 may then use a lending module 134. A lending module 134 may determine a lending authority associated with an authorized user. When the lending module 134 determines that an item requiring lending is within the lending authority associated with the authorized user, the vector exceptions system 130 may communicate the item requiring lending to the financial institution system 120 where an overdraft lending may be approved in, for example, a vector exceptions module 124.

When a lending module 134 determines that an item requiring lending is not within the lending authority associated with the authorized user, the vector exceptions system 130 may access, for example, an email module 136 or other like module that allows similar communication s (e.g., an instant message module and the like as described below. An email module 136 may determine whether email approval is capable and, if so, transmit an approval request to a vector exceptions authorized user with a lending authority amount greater than the item requiring lending approval. The email module 136 may also provide the vector exceptions module 124 with a listing of users with the necessary lending authority, where the vector exceptions module 124 may allow for selection of a specific user with the necessary lending authority to contact for lending approval.

While an email module 136 is used through the specification, the email module 136 may also transmit secure messages using a variety of electronic communications, including but not limited to, email, MMS, SMS, EMS, instant message, or any other form of communication supported by the network 110. The email module 136 may also receive a lending decision from another authorized user associate of the Vector Exceptions system 130 (an approval or denial) which may then be relayed or otherwise provided to the financial institution system 120 via the input/output module 138. In addition, email module 136 may provide the user receiving the email with the lending decision information, such as, for example, account data, customer data, and/or any comments the originating associate may provide.

FIG. 3 is a flowchart illustrating a method 301 for determining whether to extend lending to cover an overdraft according to a particular embodiment. Method 301 may begin at step 300. At step 302, a vector exceptions system 130 may receive authorized vector exceptions credentials from a financial institution system 120. The vector exceptions credentials will have been verified at the financial institution system 130 via the vector exceptions module 124. At step 304, a NSF module 132 at the vector exceptions system 130 makes an initial determination of whether or not to move forward with payment for an item associated with an account with non-sufficient funds. This initial determination may be triggered by or made as a result of, for example, a request for a transaction authorization received from a merchant. If the NSF decision is denied, the vector exceptions system 130 returns the item request to the financial institution system 120 as a denied request at step 306. If the initial decision at step 304 is approved, the vector exceptions system 130 may proceed to the lending module 134 to determine if the item requesting lending is within a lending authority amount of the authorized user at step 308. At step 312, the lending module 134 determines that the item requesting lending is within the lending authority amount of the authorized user and the vector exceptions system 130 reports the authority approval results to the financial institution system 120, where the financial institution system 120 may proceed with approving the overdraft lending using the vector exceptions module 124. If the lending module 134 determines that the lending authority amount is not greater than the item requiring lending, the lending module will refer the item for a decision in vector exceptions at step 310. At step 314 the lending module 135 will determined if the email module 136 is enabled. If the email module 136 is not enabled, the lending module may provide a final decision whether or not to override the lending authority and authorize the overdraft (a determination to pay will result in step 312 describe herein and a determination not to pay will result in step 306 described herein). At step 318, if the lending module 134 determines that the email module 136 is enabled, the email module will perform an email decision process. The process may end at step 320.

FIG. 4 illustrates a method 401 for performing an email decision process within the determination of whether to extend lending to cover an overdraft (e.g., email decision process 318), in further detail. At step 400, the email module 136 may search for at least one user having a lending authority amount greater than that of the item requiring overdraft lending. In various example embodiments, email module may have access to a data store that, for example, stores a list of active email users and the email users' respective lending authority. The email module or additional modules interacting with the email module may compare the transaction overdraft amount to the respective lending authorities to identify which of the active users has lending authority to make a decision regarding the transaction (e.g., which active users have lending authority that is greater than or equal to the transaction overdraft amount). The email decision process 318 may provide the listing of users to the financial institution system 120 via the vector exceptions module 124, where the originating authorized user may select a desired approved user to message for lending approval. The email decision process 318 may also, without originating authorized user input, send out a request for lending approval to at least one user with sufficient lending authority.

The user with sufficient lending authority may receive a referral email at step 402, which may include account data, customer data, and/or any comments from the originating authorized user. The user with sufficient lending authority may review the referral email at step 404 for a decision regarding overdrawing the item. At step 406, the decision of whether or not to fund may be transmitted back to the originating authorized user via the vector exceptions system 130. Finally, at step 408, the email decision may be entered in the vector exceptions system 130 and transmitted to the financial institution system 120. The method may end at step 410.

In an example embodiment, an authorized user with sufficient lending authority may log into the vector exceptions system 130 and/or financial institution system 120 in order to directly approve or deny the overdraft lending request without responding with an approval or denial to the originating authorized user. When the authorized user with sufficient lending authority approves or denies the request without sending a response to the originating authorized user, the vector exceptions system 130 and/or financial institution system 120 may send a notification to the originating authorized user with the funding decision and/or any commentary regarding the decision.

According to the methods described herein, the vector exceptions system 130 may be able to filter and/or flag all exceptions that are at or below an authorized user's maximum authority level as well as filter and/or flag all exceptions that are at or above an authorized user's maximum authority level. The vector exceptions system 130 may also only display or make available users in the email module that match the required overdraft lending. Moreover, the email module 136 may provide information to the emailed authorized user detailing the account balance of the account holder requesting the lending, the item requesting lending, any other necessary information for the user to determine whether or not to approve the overdraft. Moreover, the email module 136 may allow an authorized user to email multiple other authorized users in order to maximize the likelihood of overdraft authorization and minimize the time associated with receiving the authorization. The email module 136 may also provide email recipients with information regarding an importance level associated with the account requesting lending, so that customers may be categorized using account data and/or customer data, and that information may be provided to authorized users making lending decisions. The email module 136 may also allow the originating authorized user to highlight a message to display a level of importance. An importance may be illustrated by marking the email a different color than other emails, making the text a different color, and/or notifying upon sending that an email is of high importance. The email module 136 may also send reminder notifications when an authorization request is not responded to within a predetermined time period. The system 100 may also include an expiration date and/or time of the authorization request as well as the account level comments. The system 100 may further make AFS signature calls. The system 100 may allow non-business day activity, however, non-business day activity for the email module 136 may be limited and even disabled. The system 100 may also prohibit remote users of the system to edit a received email. The system 100 may add historical capabilities to a history and user stats file(s) that may be stored in the financial institution system 120 so that the data can be recreated at any time.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system comprising:
a database that stores a plurality of vector exception credentials, each of the plurality of vector exception credentials having a respective lending authority amount;
a processor that receives an overdraft item request via a network and authorized vector exceptions credentials associated with the overdraft item request, the overdraft item request having an associated overdraft amount and the authorized vector exception credentials being one of the plurality of stored vector exception credentials;
a funding processor that makes an initial determination regarding funding the overdraft item request;
a lending processor that determines whether the lending authority amount of the authorized credentials is greater than or equal to the overdraft amount; and
a messaging module that generates a message to an authorized user associated with a lending authority amount greater than or equal to the overdraft amount when the lending module determines the lending authority amount is less than the overdraft amount.

2. The system of claim 1, wherein the initial determination is that the a transaction associated with the overdraft amount will result in an overdraft of an account associated with the overdraft item request.

3. The system of claim 1, wherein the messaging module generates an email message to the authorized user.

4. The system of claim 1, wherein the messaging module generates an instant message to the authorized user.

5. The system of claim 1, wherein each of the vector exception credentials have a respective messaging address associated therewith, and wherein the messaging module generates the message to the authorized user at the messaging address for the authorized user.

6. The system of claim 5, wherein the messaging module receives a reply to the message from the authorized user to authorize the overdraft item request.

7. The system of claim 1, wherein the messaging module receives a reply to the message from the authorized user to authorize the overdraft item request.

8. The system of claim 1, wherein the overdraft item request is based on an authorization request to approve a transaction.

9. The system of claim 8, wherein the transaction is a debit transaction.

10. The system of claim 9, wherein, when the initial determination is that the a transaction associated with the overdraft amount will not result in an overdraft of an account associated with the overdraft item request, the funding processor approves the transaction.

11. A method comprising:
storing, in a database, a plurality of vector exception credentials, each of the plurality of vector exception credentials having a respective lending authority amount;
receiving an overdraft item request via a network and authorized vector exceptions credentials associated with the overdraft item request, the overdraft item request having an associated overdraft amount and the authorized vector exception credentials being one of the plurality of stored vector exception credentials;
making, using a funding processor, an initial determination regarding funding the overdraft item request;
determining, using a lending processor, whether the lending authority amount of the authorized credentials is greater than or equal to the overdraft amount; and
generating, using a messaging module, a message to an authorized user associated with a lending authority amount greater than or equal to the overdraft amount when the lending module determines the lending authority amount is less than the overdraft amount.

12. The method of claim 11, wherein the initial determination is that the a transaction associated with the overdraft amount will result in an overdraft of an account associated with the overdraft item request.

13. The method of claim 11, further comprising generating an email message to the authorized user.

14. The method of claim 11, further comprising generating an instant message to the authorized user.

15. The method of claim 11, wherein each of the vector exception credentials have a respective messaging address associated therewith, and wherein the method further comprises generating the message to the authorized user at the messaging address for the authorized user.

16. The method of claim 15, further comprising receiving, at the messaging module, a reply to the message from the authorized user to authorize the overdraft item request.

17. The method of claim 11, further comprising receiving, at the messaging module, a reply to the message from the authorized user to authorize the overdraft item request.

18. The method of claim 11, wherein the overdraft item request is based on an authorization request to approve a transaction.

19. The method of claim 18, wherein the transaction is a debit transaction.

20. The method of claim 19, wherein, when the initial determination is that the a transaction associated with the overdraft amount will not result in an overdraft of an account associated with the overdraft item request, the funding processor approves the transaction.
